(19) United States
(12) Patent Application Publication
(10) Pub. No.: US 2009/0150954 A1
(43) Pub. Date: Jun. 11, 2009

(54) SERVER AND METHOD FOR CONTROLLING CUSTOMER PREMISES CABLE MODEM BASED ON CONFIGURATION INFORMATION

(76) Inventors: TaeKyoon KIM, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/324,912

(22) Filed: Nov. 28, 2008

(30) Foreign Application Priority Data
Dec. 5, 2007 (KR) 10-2007-0125469

(51) Int. Cl. H04N 7/173

(52) U.S. Cl. 725/111

(57) ABSTRACT

Disclosed are a server and method for controlling a customer premises cable modem based on configuration information. The configuration information control server includes a basic configuration information managing module to generate basic configuration information included in the configuration information for controlling the customer premises cable modem, and transmit the generated basic configuration information to the customer premises cable modem, a supplementary configuration information managing module to generate supplementary configuration information included in the configuration information, and transmit the generated supplementary configuration information to the customer premises cable modem, and a control module to determine whether either the basic configuration information or the supplementary configuration information is required to be transmitted to the customer premises cable modem.

### CROSS-REFERENCE TO RELATED APPLICATION

This application claims the benefit of Korean Patent Application No. 10-2007-0125469, filed on Dec. 5, 2007, in the Korean Intellectual Property Office, the entire disclosure of which is incorporated herein by reference.

### BACKGROUND OF THE INVENTION

1. Field of the Invention

The present invention relates to a server and method for controlling a customer premises cable modem based on configuration information, and more particularly, to a server and method for controlling a customer premises cable modem based on configuration information which may manage the configuration information to have a dual structure, thereby effectively controlling the customer premises cable modem.

This work was supported by the IT R&D program of MIC/IITA. [2006-S-019-02, Development of Digital Cable Transmission and Receive System for 1 Gbps Downstream]

2. Description of Related Art

Configuration information for controlling a customer premises cable modem may be downloaded through a Trivial File Transfer Protocol (TFTP), and have a binary file format. The configuration information of the customer premises cable modem may encode variables used for determining at least one configuration information. The customer premises cable modem may be required to process determination of all standard configuration information, and ignore non-interpretable information.

In general, the configuration information may include basic configuration information being necessarily included in the configuration information at the time of determination of the standard configuration information and supplementary configuration information not being necessarily included in the same. A conventional configuration information file may be required to transmit configuration information including both of the basic configuration information and the supplementary configuration information when the configuration information including both thereof is transmitted to the customer premises cable modem to change determination of the customer premises cable modem.

However, the basic configuration information is information being necessarily included in the configuration information and having a significantly low possibility of being changed, and the supplementary configuration information is information not being necessarily included in the same and having a significantly high possibility of being changed such as occasionally being added or deleted as necessary.

Thus, in the conventional art, there is a problem in that the configuration information including the basic configuration information having the significantly less possibility of being changed is transmitted to the customer premises cable modem, thereby failing to acquire rapid and effective management of the customer premises cable modem.

### SUMMARY OF THE INVENTION

An aspect of the present invention provides a configuration information control server and method thereof which may manage configuration information to have a dual structure composing basic configuration information and supplementary configuration information, so that when the basic configuration information or the supplementary configuration information is changed, only the changed configuration information is transmitted to the customer premises cable modem.

An aspect of the present invention provides a configuration information control server and method thereof which may transmit only the changed configuration information to the customer premises cable modem, thereby rapidly and effectively managing the customer premises cable modem.

According to an aspect of the present invention, there is provided a configuration information control server for controlling a customer premises cable modem based on configuration information, the configuration information control server including: a basic configuration information managing module to generate basic configuration information included in the configuration information for controlling the customer premises cable modem, and transmit the generated basic configuration information to the customer premises cable modem; a supplementary configuration information managing module to generate supplementary configuration information included in the configuration information, and transmit the generated supplementary configuration information to the customer premises cable modem; and a control module to determine whether either the basic configuration information or the supplementary configuration information is required to be transmitted to the customer premises cable modem.

According to an aspect of the present invention, there is provided a method for controlling a customer premises cable modem based on configuration information, the method including: generating configuration information including basic configuration information and supplementary configuration information, for controlling the customer premises cable modem; determining whether either the basic configuration information or the supplementary configuration information is required to be transmitted to the customer premises cable modem; and transmitting either the basic configuration information or the supplementary configuration information to the customer premises cable modem according to the determined result.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating a cable network system including a configuration information control server according to an exemplary embodiment of the present invention;

FIG. 2 is a block diagram illustrating a configuration of a configuration information control server according to an exemplary embodiment of the present invention;

FIG. 3 is a diagram illustrating basic configuration information stored and managed in a basic configuration information managing module according to an exemplary embodiment of the present invention;

FIG. 4 is a diagram illustrating supplementary configuration information stored and managed in a supplementary configuration information managing module according to an exemplary embodiment of the present invention;

FIG. 5 is a flowchart illustrating a method for controlling a customer premises cable modem based on configuration information according to an exemplary embodiment of the present invention; and

FIG. 6 is a flowchart illustrating a process where a configuration information file is generated through inputting by a user for the purpose of generation of configuration information according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

when detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

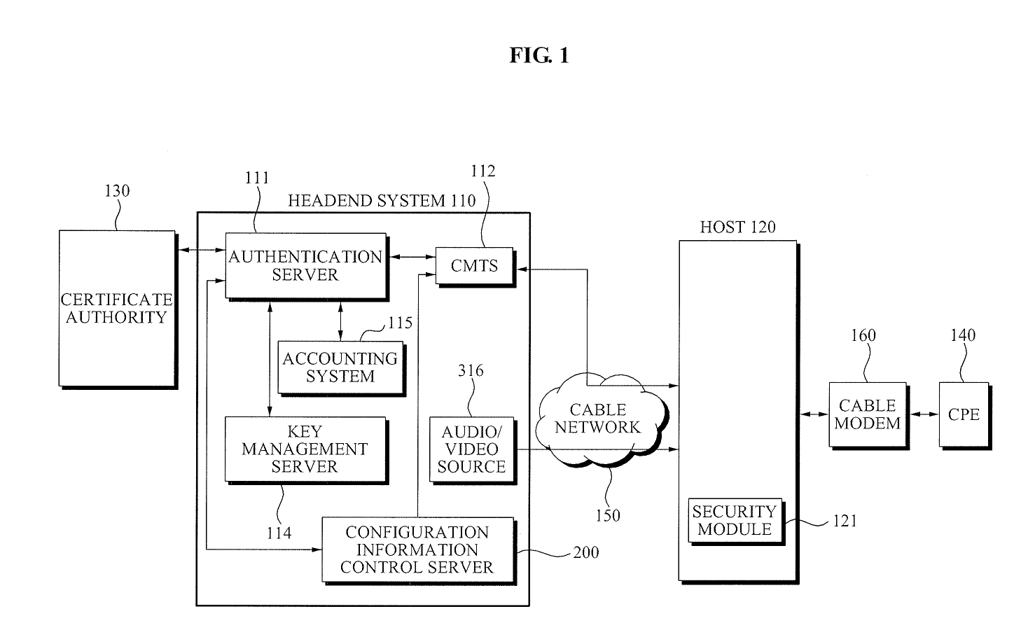

FIG. 1 is a diagram illustrating a cable network system including a configuration information control server according to an exemplary embodiment of the present invention.

Referring to FIG. 1, the cable network system according to the present exemplary embodiment of the invention may include a headend system 110 including a configuration information control server 200, and a customer premises equipment (CPE) 140 connected via a customer premises cable modem 160 using a cable network 150 such as a Hybrid Fiber Coax (HFC) network.

The headend system 110 may transmit audio/video sources and data signals to the customer premises equipment 140 via a cable modem termination system 112.

A certificate authority 130 may perform a stable communication with an authentication server 111 of the headend system 110, and provide information required for the authentication. The authentication server 111 may transmit information used for generating a session key required for the authentication to a security module 121 via the cable modem termination system 112.

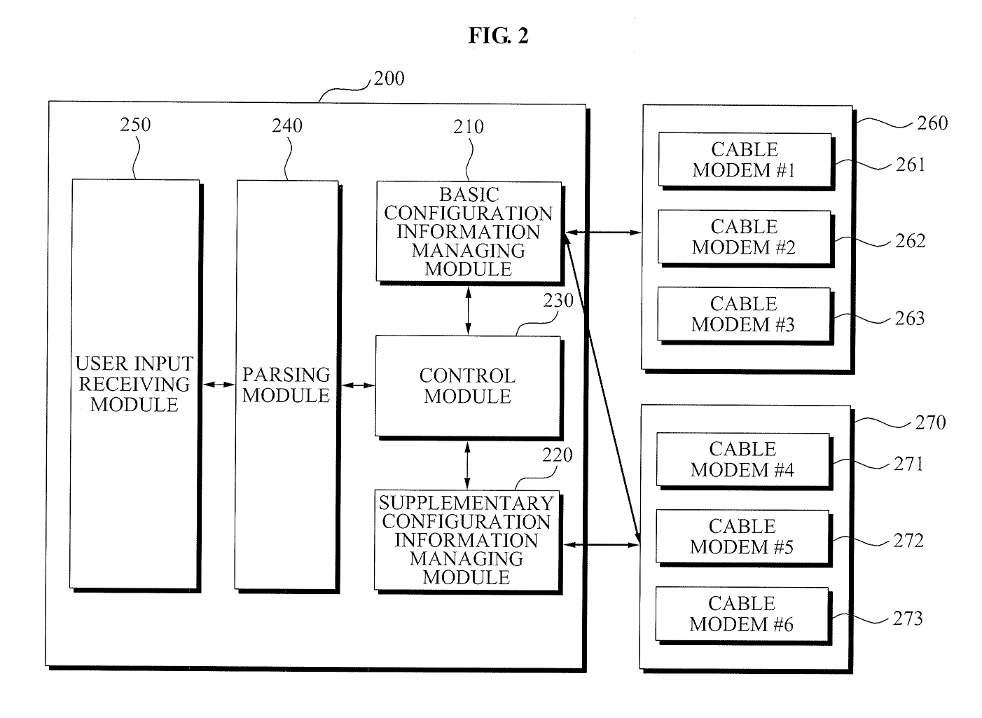

The configuration information control server 200 of the headend system 110 may transmit configuration information to the customer premises cable modem 160 via the cable modem termination system 112 in order to control and manage the customer premises cable modem 160. The configuration information control server 200 may store and manage a configuration information file of a dual structure in which basic configuration information having a relatively low possibility of change and supplementary configuration information having a relatively high possibility of change are divided. The configuration information control server 200 may transmit configuration information having the dual structure to the customer premises cable modem 160, thereby rapidly and effectively controlling the customer premises cable modem 160. The configuration information control server 200 will be herein described in detail with reference to FIG. 2.

FIG. 2 is a block diagram illustrating a configuration of a configuration information control server 200 according to an exemplary embodiment of the present invention.

Referring to FIG. 2, the configuration information control server 200 according to the present exemplary embodiment of the invention includes a basic configuration information managing module 210, a supplementary configuration information managing module 220, and a control module 230.

The basic configuration information managing module 210 may generate basic configuration information included in configuration information for controlling a customer premises cable modem, and transmit the generated basic configuration information to the customer premises cable modem.

The supplementary configuration information managing module 220 may generate supplementary configuration information included in the configuration information, and transmit the generated supplementary configuration information to the customer premises cable modem.

Also, the control module 230 may determine whether the basic configuration information and/or the supplementary configuration information is required to be transmitted to the customer premises cable modem. Then, the control module 230 may transmit the determined result to the basic configuration information managing module 210 and/or the supplementary configuration information managing module 220, and control the transmission of the basic configuration information and/or the supplementary configuration information according to the determined result.

Specifically, the control module 230 may determine whether the basic configuration information and/or the supplementary configuration information concerning the customer premises cable modem is changed, and then determine whether the basic configuration information or the supplementary configuration information is required to be transmitted to the customer premises cable modem, thereby controlling the transmission of the basic configuration information and/or the supplementary configuration information. The configuration information control server 200 according to the present exemplary embodiment of the invention may determine whether the basic configuration information and/or the supplementary configuration information is changed, and transmit configuration information only with respect to the changed configuration information, thereby rapidly controlling the customer premises cable modem.

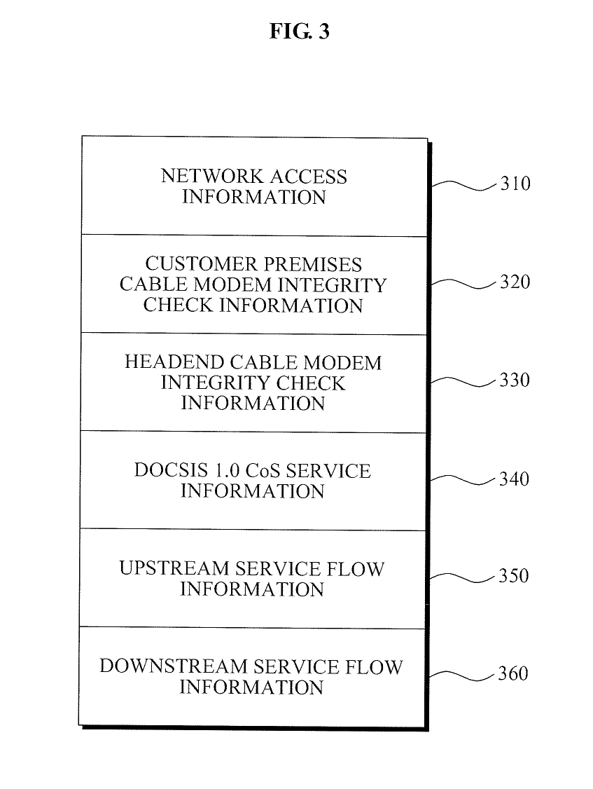

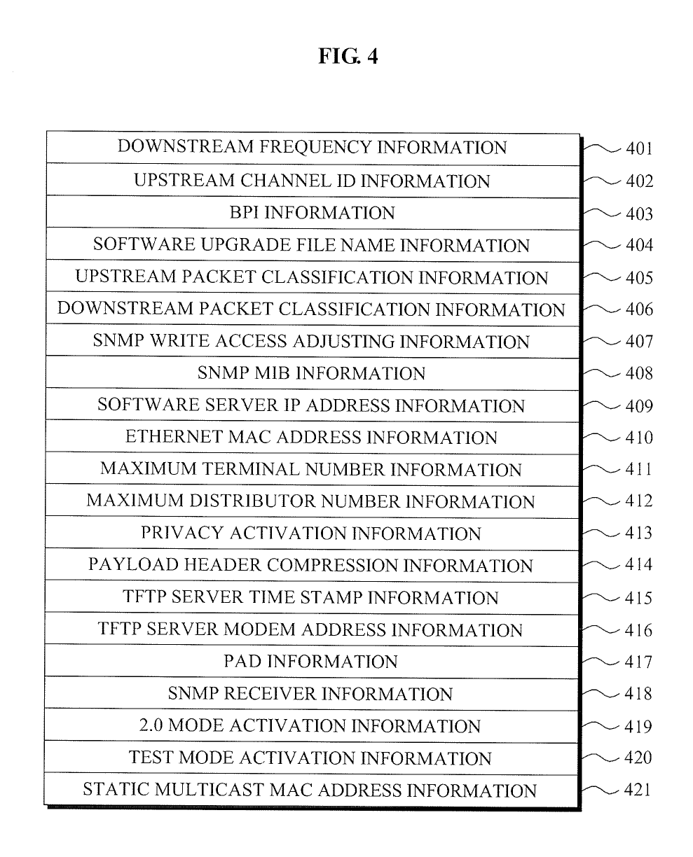

Also, the control module 230 may determine whether the supplementary configuration information concerning the customer premises cable modem is changed, and control transmission of the supplementary configuration information to the customer premises cable modem. Specifically, the control module 230 may determine whether only the supplementary configuration information having a relatively high possibility of change is changed unlike the basic configuration information having a relatively low possibility of change, and transmit the changed supplementary configuration information to the customer premises cable modem, thereby more effectively controlling the customer premises cable modem. Hereinafter, basic configuration information and supplementary configuration information will be described in detail with reference to FIGS. 3 and 4.

FIG. 3 is a diagram illustrating basic configuration information stored and managed in a basic configuration information managing module according to an exemplary embodiment of the present invention.

Referring to FIG. 3, the basic configuration information according to the present exemplary embodiment of the invention may include network access information 310, customer premises cable modem integrity check information 320, headend cable modem integrity check information 330, Class of Service (CoS) service information 340, upstream service flow information 350, and a downstream service flow information 360.

The network access information 320 may include information related with network access of the customer premises cable modem with respect to the cable network. The customer premises cable modem integrity check information 320 may include information used for integrity check with respect to the customer premises cable modem, and the headend cable modem integrity check information 330 may include information used for integrity check with respect to the cable modem termination system or headend cable modem included in the headend system.

Also, the CoS service information 340 may include bandwidth guaranteed CoS information according to a priority of an essential application.

The upstream service flow information 350 may include information about an upstream service flow, and the downstream service may include information about a downstream service flow.

FIG. 4 is a diagram illustrating supplementary configuration information stored and managed in a supplementary configuration information managing module according to an exemplary embodiment of the present invention.

The supplementary configuration information stored and managed in the supplementary configuration information managing module may include downstream frequency information 401, upstream channel Identification (ID) information 402, Bytes Per Inch (BPI) information 403, software upgrade file name information 404, upstream packet classification information 405, downstream packet classification information 406, Simple Network Management Protocol (SNMP) write access adjusting information 407, SNMP Management Information Base (MIB) information 408, software server IP address information 409, Ethernet Media Access Control (MAC) address information 410, maximum terminal number information 411, maximum distributor number information 412, privacy activation information 413, payload header compression information 414, Trivial File Transfer Protocol (TFTP) server time stamp information 415, TFTP server modem address information 416, Packet Assembly and Disassembly (PAD) information 417, SNMP receiver information 418, 2.0 mode activation information 419, test mode activation information 420, and static multicast MAC address information 421.

The downstream frequency information 401 may include information about a frequency for providing a downstream service, the upstream channel ID information 402 may include information for identifying a channel for providing an upstream service, and the BPI information 403 may include information about a basic privacy interface.

Also, the software upgrade file name information 404 may include information about a file for software upgrade, the upstream packet classification information 405 may include information for classifying upstream packets, and the downstream packet classification information 406 may include information for classifying downstream packets.

Also, the SNMP write access adjusting information 407 may include information about a function for adjusting SNMP write access, the SNMP MIB information 408 may include information about SNMP MIB, and the software server IP address information 409 may include information about an IP address of a software server.

Also, the Ethernet MAC address information 410 may include information about an Ethernet MAC address, the maximum terminal number information 411 may include information about a maximum number of connectable terminals, and the maximum distributor number information 412 may include information about a maximum number of distributors.

Also, the privacy activation information 413 may include information about privacy activation, the payload header compression information 414 may include information about payload header compression, and the TFTP server time stamp information 415 may include information about time stamp of a TFTP server.

Also, the TFTP server modem address information 416 may include information about a TFTP server modem address, the PAD information 417 may include information about PAD, and the SNMP receiver information 418 may include information about a SNMP receiver.

Also, the 2.0 mode activation information 419 may include information for activating a 2.0 mode, the test mode activation information 420 may include information for activating a test mode for the purpose of performance verification, and the static multicast MAC address information 421 may include information about an MAC address for the purpose of static multicasting.

Referring again to FIG. 2, the configuration information control server 200 according to the present invention may further include a user input receiving module 250 to receive, from a user, user input information for generating the configuration information, and a parsing module 240 to parse the user input information received via the user input module 250 and convert the parsed user input information into structured encoding information. The parsing module 240 may transmit the configuration information, received from the user and converted into the encoding information, to the control module 230, and the control module 230 may control the transmitted configuration information to be managed in either the basic configuration information managing module 210 or the supplementary configuration information managing module 220 according to characteristics of the configuration information.

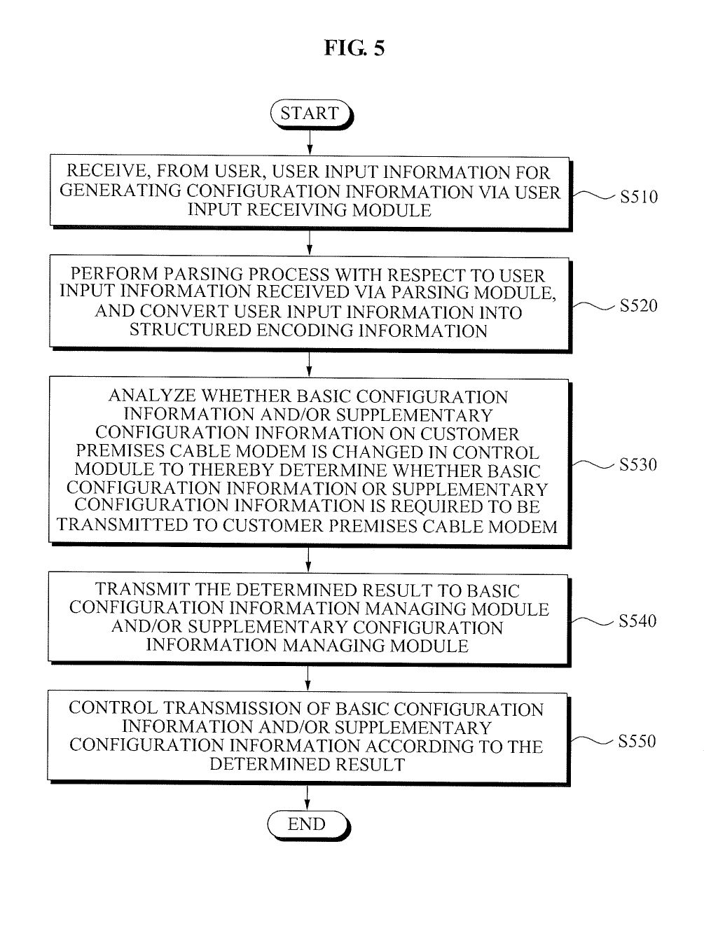

FIG. 5 is a flowchart illustrating a method for controlling a customer premises cable modem based on configuration information according to an exemplary embodiment of the present invention.

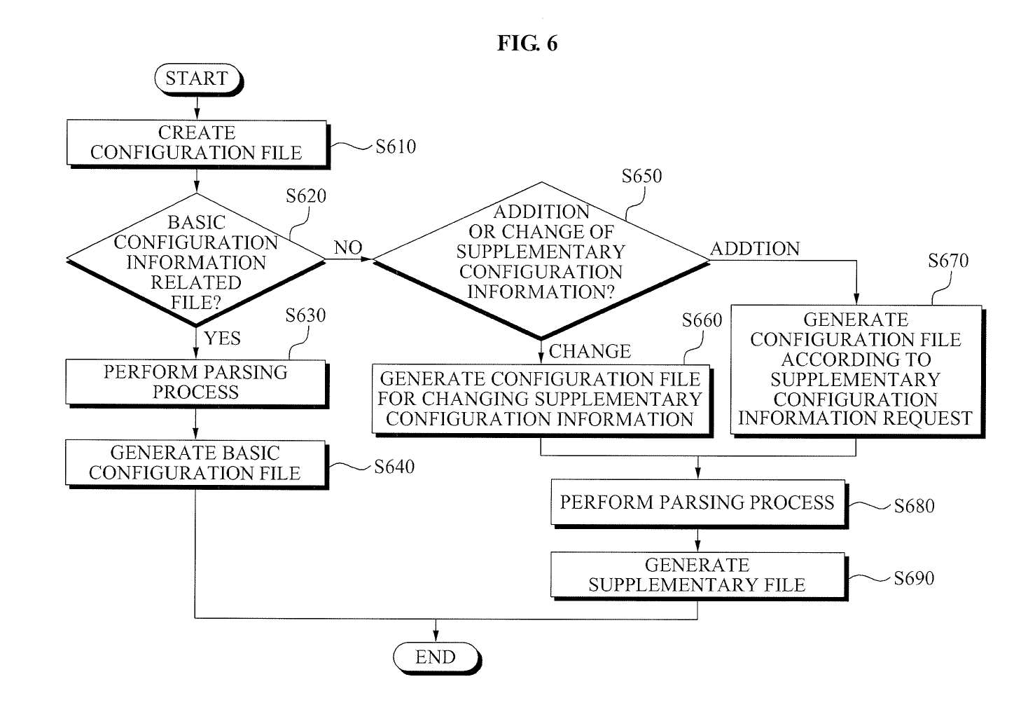

Referring to FIG. 5, the configuration information control server may generate configuration information including basic configuration information and supplementary configuration information for controlling the customer premises cable modem. Specifically, in operation S510, the configuration information control server may receive, from a user, user input information for generating the configuration information via the user input receiving module. In operation S520, the configuration information control server may perform a parsing process with respect to the received user input information, and convert the user input information into structured encoding information to thereby generate the configuration information. The generation of the configuration information will be herein described in detail with reference to FIG. 6.

FIG. 6 is a flowchart illustrating a process where a configuration information file is generated through inputting by a user for the purpose of generation of configuration information according to an exemplary embodiment of the present invention.

Referring to FIG. 6, in operation S610, a configuration file, that is, an encoding file including configuration information is created by the user using the user input receiving module. Next, in operation S620, the parsing module determines whether the configuration file is a file related with basic configuration information, that is, determines whether the user input information is either the basic configuration information or the supplementary configuration information. In operation S630, a parsing process is performed with respect to the configuration file using the parsing module when the configuration file is the file related with the basic configuration information. In operation S640, the configuration file is converted into a structured encoding information to thereby generate a basic configuration file. The basic configuration file may be stored and managed in the basic configuration information managing module.

Conversely, in operation S650, when the configuration file is a file related with the supplementary configuration information, the parsing module determines whether the supplementary configuration information related file is related with addition or change. In operation S660, when the supplementary configuration information related file is a file related with the change, a configuration file for change in the supplementary configuration information is generated. In operation S680, a parsing process is performed with respect to the configuration file using the parsing module. In operation S690, the configuration file is converted into a structured encoding information to thereby generate a supplementary configuration file. However, in operation S670, when the supplementary configuration information related file is a file related with the addition, a configuration file for addition of the supplementary configuration information is generated. In operation S680, a parsing process is performed with respect to the configuration file using the parsing module. In operation S690, the configuration file is converted into the structured encoding information to thereby generate the supplementary configuration file. The supplementary configuration file may be stored and managed in the supplementary configuration information managing module.

Referring again to FIG. 5, the configuration information of the basic configuration file or supplementary configuration file types is generated, and then whether the basic configuration information and/or the supplementary configuration information is required to be transmitted to the customer premises cable modem is determined. In operation S530, the control module analyzes whether the basic configuration information and/or the supplementary configuration information concerning the customer premises cable modem is changed, and then determines whether the basic configuration information and/or the supplementary configuration information is required to be transmitted to the customer premises cable modem.

Next, the basic configuration information and/or the supplementary configuration information is transmitted to the customer premises cable modem according to the determined result. In operation S540, the control module determines the basic configuration information and/or the supplementary configuration information is required to be transmitted to the customer premises cable modem, and transmits the determined result to the basic configuration information managing module and/or the supplementary configuration information managing module. In operation S550, the control module controls transmission of the basic configuration information and/or the supplementary configuration information according to the determined result.

The method for controlling the customer premises cable modem based on configuration information according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, according to the present invention, the configuration information is managed to have a dual structure composing basic configuration information and supplementary configuration information, so that when either the basic configuration information or the supplementary configuration information is changed, only the changed configuration information is transmitted to the customer premises cable modem.

According to the present invention, only the changed configuration information is transmitted to the customer premises cable modem, thereby rapidly and effectively managing the customer premises cable modem.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A configuration information control server for controlling a customer premises cable modem based on configuration information, the configuration information control server comprising:
a basic configuration information managing module to generate basic configuration information included in the configuration information for controlling the customer premises cable modem, and transmit the generated basic configuration information to the customer premises cable modem;
a supplementary configuration information managing module to generate supplementary configuration information included in the configuration information, and transmit the generated supplementary configuration information to the customer premises cable modem; and
a control module to determine whether either the basic configuration information or the supplementary configuration information is required to be transmitted to the customer premises cable modem.

2. The configuration information control server of claim 1, wherein the control module transmits the determined result to either the basic configuration information managing module or the supplementary configuration information managing module, and controls transmission of the basic configuration information or the supplementary configuration information corresponding to the determined result.

3. The configuration information control server of claim 1, wherein the control module determines whether either the basic configuration information or the supplementary configuration information concerning the customer premises cable modem is changed, thereby determining whether either the basic configuration information or the supplementary configuration information is required to be transmitted to the customer premises cable modem.

4. The configuration information control server of claim 1, wherein the control module determines whether the supplementary configuration information is changed concerning the customer premises cable modem, thereby controlling transmission of the supplementary configuration information to the customer premises cable modem.

5. The configuration information control server of claim 1, wherein the basic configuration information includes network access information including information related to network access of the customer premises cable modem with respect to a cable network.

6. The configuration information control server of claim 1, wherein the basic configuration information includes terminal cable modem integrity check information including information of an integrity check of the customer premises cable modem, and headend cable modem integrity check information including information of an integrity check of a headend cable modem included in a headend system.

7. The configuration information control server of claim 1, wherein the basic configuration information includes upstream service flow information including bandwidth guaranteed Class of Service (CoS) information according to a priority of an essential application and information about an upstream service flow, and downstream service flow information including information about a downstream service flow.

8. The configuration information control server of claim 1, wherein the supplementary configuration information includes downstream frequency information including information about a frequency for providing a downstream service, upstream channel identification information including information for identifying a channel for providing an upstream service, and Baseline Privacy Interface (BPI) information including information about BPI.

9. The configuration information control server of claim 1, wherein the supplementary configuration information includes software upgrade file name information about a file for software upgrade, upstream packet classification information for classifying an upstream packet, and downstream packet classification information for classifying a downstream packet.

10. The configuration information control server of claim 1, wherein the supplementary configuration information includes Simple Network Management Protocol (SNMP) write access adjusting information for adjusting SNMP write access, and Internet Protocol (IP) address information including an IP address of a software server.

11. The configuration information control server of claim 1, wherein the supplementary configuration information includes Ethernet Media Access Control (MAC) address information with respect to an Ethernet MAC address, maximum terminal number information with respect to a maximum number of connectable terminals, and maximum distributor number information about a maximum number of distributors.

12. The configuration information control server of claim 1, wherein the supplementary configuration information includes privacy activation information with respect to privacy activation, payload header compression information with respect to payload header compression, and time stamp information with respect to a time stamp of a Trivial File Transfer Protocol (TFTP) server.

13. The configuration information control server of claim 1, further comprising:
a user input receiving module to receive, from a user, user input information for generating the configuration information; and
a parsing module to parse the user input information received via the user input module, and convert the parsed user input information into structured encoding information.

14. A method for controlling a customer premises cable modem based on configuration information, the method comprising:
generating configuration information including basic configuration information and supplementary configuration information, for controlling the customer premises cable modem;
determining whether either the basic configuration information or the supplementary configuration information is required to be transmitted to the customer premises cable modem; and
transmitting either the basic configuration information or the supplementary configuration information to the customer premises cable modem according to the determined result.

15. The method of claim 14, wherein the generating of the configuration information includes:
receiving, from a user, user input information for generating the configuration information via a user input receiving module; and
parsing the user input information received via a parsing module, and converting the parsed user input information into structured encoding information.

16. The method of claim 15, wherein the parsing includes determining whether the user input information is either the basic configuration information or the supplementary configuration information.

17. The method of claim 14, wherein the determining includes:
analyzing whether either the basic configuration information or the supplementary configuration information on the customer premises cable modem is changed in a control module, thereby determining whether either the basic configuration information or the supplementary configuration information is required to be transmitted to the customer premises cable modem,
wherein the transmitting includes:
transmitting the determined result to either the basic configuration information managing module or the supplementary configuration information managing module.

18. The method of claim 17, wherein the transmitting of the determined result includes controlling transmission of the basic configuration information or the supplementary configuration information in the control module according to the determined result.
